(19) United States
(12) Patent Application Publication
(10) Pub. No.: US 2022/0030785 A1
(43) Pub. Date: Feb. 3, 2022

(54) FAULT NOTIFICATION SYSTEM AND METHOD FOR USE WITH AN IRRIGATION SYSTEM

(71) Applicant: LINDSAY CORPORATION, OMAHA, NE (US)

(72) Inventors: Mark William Miller, Elkhorn, NE (US); Reece Robert Andrews, Arlington, NE (US); Richard E. Provaznik, Omaha, NE (US)

(73) Assignee: LINDSAY CORPORATION, OMAHA, NE (US)

(21) Appl. No.: 16/941,765

(22) Filed: Jul. 29, 2020

(51) Int. Cl. A01G 25/16; H04Q 9/00; B05B 12/00; B05B 12/12; F16H 57/01; F16H 57/04; G05B 19/042; G05B 23/02; H02H 7/08; H02H 1/00; B60C 23/04

(52) U.S. Cl. CPC A01G 25/16; H04Q 9/00; B05B 12/004; B05B 12/12; F16H 57/01; F16H 57/0405; A01G 25/092; G05B 23/0218; H02H 7/08; H02H 1/0007; H02H 1/0092; B60C 23/04; H04Q 2213/002; G05B 19/042

(57) ABSTRACT

A fault notification system comprises a plurality of tower sensor units and a central processing element. Each tower sensor unit includes a tower safety sensor and a tower processing element. The tower safety sensor monitors a rotation angle of a mobile tower and output a signal that varies according to the rotation angle. The tower processing element is configured to receive the signal, compare a signal level of the signal with a range of signal levels indicating a normal rotation angle, and transmit a message that a fault has occurred and request that each drive motor shut down if the level of the signal is out of the range indicating a normal rotation angle. The central processing element is configured to receive the message from the tower processing element and transmit a signal to each tower processing element to output a signal to instruct each drive motor to shut down.

### FIELD OF THE INVENTION

Embodiments of the current invention relate to systems and methods that provide notification when a fault occurs in components of an irrigation system.

### BACKGROUND

Crops are cultivated throughout the world in a wide variety of climates with different terrains and soils. It is desirable in many of these climates to artificially supplement the climate's natural precipitation via irrigation systems to ensure crops receive adequate water. Additionally, irrigation systems can be used to deliver fertilizers and chemicals to, among other things, promote healthy crop growth, suppress weeds, and protect crops from frost.

Common irrigation systems include center-pivot systems and lateral-move systems, each having an elevated, elongated pipe supported by a plurality of mobile towers spaced along the pipe. The pipe includes a plurality of spaced sprinklers that may extend downward toward the crops to enable distribution of water to the crops from above. Center-pivot systems are ideal for use in fields having circular crop areas and generally include a hydrant located in the middle of each circular crop area. In such systems, a plurality of spans are linked together radially outward from the hydrant. Each span includes a tower and a truss assembly that supports the pipe and the sprinklers which deliver water to the crop area while the spans rotate about the hydrant. Lateral-move systems are ideal for use in square, rectangular, and irregular-shaped fields. Such systems generally include one or more hydrants located in and/or adjacent to a field and/or one or more ditches located along or through a field that are connected to the pipe and the sprinklers. Unlike the center-pivot system having a pipe with a stationary end, the pipe in a lateral-move system is connected to and extends from a movable cart designed to traverse up and down a cart path. The pipe may be locked at an angle perpendicular to the cart path and pivot at an end at the cart path, which is desirable if the cart path extends down the middle of a field to enable pivoting from one side of the cart path to the other with each pass along the cart path.

In both center-pivot and lateral move systems, each span may have a length, for example, of one hundred thirty five feet to two hundred feet. In center-pivot systems, there may be dozens of spans. To move the span during an irrigation operation, each of the mobile towers includes two or more wheels that are fixed in orientation and driven by a mechanical drive unit. The mechanical drive units may be a series of electric motors or other similar sources of propulsion. In general, the mechanical drive units propel the span forward or backward in a circular or lateral pattern along a field and over crops, to provide crop irrigation.

During operation of the irrigation system, problems may arise. For example, one or more or the mobile towers may become oriented at an unsafe angle, such as being caught in a rut, encountering a slope that is too steep, being blown over, encountering an object, or the like. Other examples of problems include a mechanical drive unit having an electrical fault, such as a short circuit, a mechanical drive unit having a gearbox fault, tires having low pressure, and so forth. The irrigation system may monitor for the occurrence of these problems or faults and may shut down operation if any of them occur. However, the irrigation system may lack the ability to identify in what mobile tower the problem or fault actually occurred, possibly requiring lengthy inspection to discover the source of the problem or fault.

### SUMMARY OF THE INVENTION

Embodiments of the current invention solve the above-mentioned problems and provide a distinct advance in the art of monitoring an irrigation system for faults. Specifically, embodiments of the current invention may provide a fault notification system and methods for monitoring an irrigation system including a plurality of mobile towers and a plurality of spans, each mobile tower including a drive motor and each span positioned between two adjacent mobile towers, for mobile tower alignment faults and issuing a notification when an alignment fault occurs. The fault notification system broadly comprises a plurality of tower sensor units and a central processing element. Each tower sensor unit includes a tower safety sensor and a tower processing element. The tower safety sensor is configured to monitor or sense a relationship at each mobile tower between an inward span and an outward span and output a tower safety signal or digital data that varies according to the relationship. The tower processing element is configured or programmed to receive the tower safety signal or digital data from the tower safety sensor, compare a signal level or data value of the tower safety signal or digital data with a range of signal levels or data values indicating a normal relationship, and generate and transmit a message that a fault has occurred. The central processing element is configured or programmed to receive the message from the tower processing element, and communicate a notification to a user interface, the notification indicating which mobile tower has the fault.

One method broadly comprises receiving, with each of a plurality of tower processing elements, a tower safety signal or data from a successive one of a plurality of tower safety sensors, each tower safety sensor configured to monitor a rotation angle of an outward mobile tower relative to an inward mobile tower, each tower processing element associated with a successive one of the mobile towers; comparing, with each tower processing element, the tower safety signal or data to a range of signal levels or data values that indicate a normal rotation angle; generating and transmitting, with at least one tower processing element, a message that indicates an alignment fault and requests a shut down of at least one drive motor in the irrigation system if the tower safety signal or data has a level or value that is out of the range of levels or values for a normal rotation angle; receiving, with a central processing element, the message; generating and transmitting, with the central processing element, a shut down signal or data to each tower processing element to shut down at least one drive motor; and outputting, with each tower processing element, a drive motor signal or digital data with a signal level or data value that shuts the associated drive motor off.

Another method broadly comprises receiving, with each of a plurality of tower processing elements, signals or data from a plurality of sensors, each sensor configured to monitor an operation of a successive one of a plurality of irrigation system components, each tower processing element associated with a successive one of the mobile towers; comparing, with each tower processing element, each signal or data to a range of signal levels or data values that indicate normal operation of the irrigation system component; generating and transmitting, with at least one tower processing element, a message which indicates a fault and requests a shut down of at least one drive motor in the irrigation system if any of the signals or data has a level or value that is out of the range of levels or values that indicate normal operation of the irrigation system component; receiving, with a central processing element, the message; generating and transmitting, with the central processing element, a shut down signal or data to each tower processing element to shut down at least one drive motor; and outputting, with each tower processing element, a drive motor signal or digital data with a signal level or data value that shuts the associated drive motor off.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is an upper perspective environmental view of an irrigation system including a fault notification system constructed in accordance with various embodiments of the invention;

FIG. 2 is an upper perspective view of a mobile tower of the irrigation system, highlighting a joint between a first section of a conduit and a second section of the conduit;

FIG. 3 is a lower perspective view of components that monitor or sense a rotation angle between adjacent mobile towers;

FIG. 4 is a top view of the irrigation system highlighting rotation angles between the mobile towers;

FIG. 5 is a schematic block diagram of electronic components of a tower sensor unit;

FIG. 6 is a schematic block diagram of electronic components of the fault notification system;

FIG. 7 is a schematic block diagram of electronic components of an alternative embodiment of the fault notification system;

FIG. 8 is a listing of at least a portion of the steps of a method for monitoring an irrigation system including a plurality of mobile towers, each mobile tower including a drive motor, for mobile tower alignment faults and issuing a notification when an alignment fault occurs; and

FIG. 9 is a listing of at least a portion of the steps of a method for monitoring an irrigation system including a plurality of mobile towers, each mobile tower including a drive motor, for faults and issuing a notification when a fault occurs.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

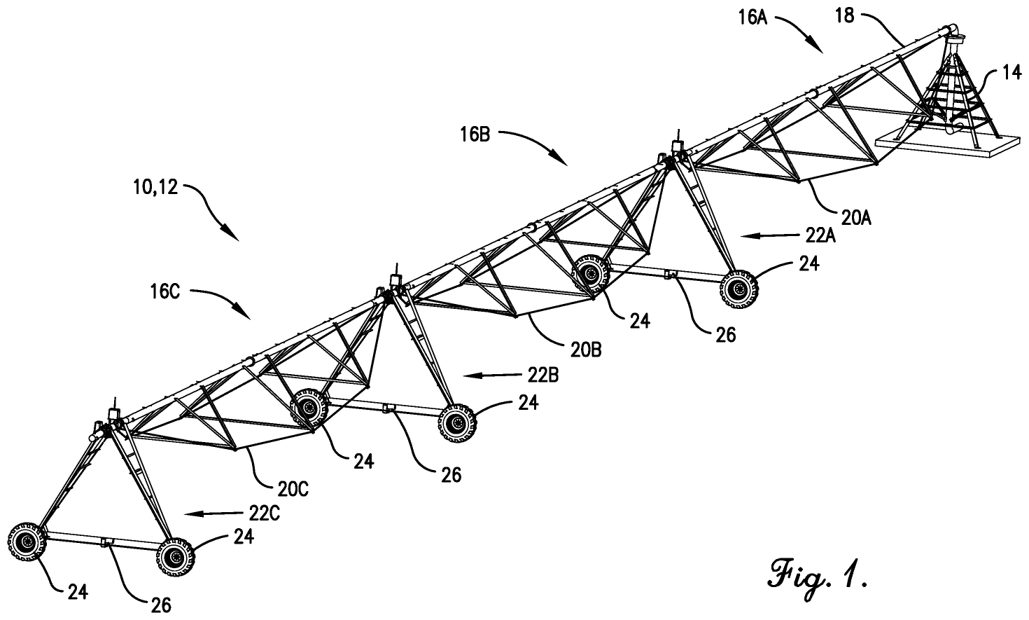

An irrigation system 10 comprising a fault notification system 12, constructed in accordance with various embodiments of the current invention, is shown in FIG. 1. An exemplary irrigation system 10 is a central pivot irrigation system and broadly comprises a fixed central pivot 14 and a plurality of spans 16 pivotally connected to the central pivot. The irrigation system 10 may also comprise an extension arm (also commonly referred to as a “swing arm” or “corner arm”) pivotally connected to the free end of the outermost span 16. The irrigation system 10 may also be embodied by a lateral, or linear, move apparatus without departing from the scope of the current invention.

The fixed central pivot 14 may be a tower or any other support structure about which the spans 16 pivot or rotate. The central pivot has access to a well, water tank, or other source of water and may also be coupled with a tank or other source of agricultural products to inject fertilizers, pesticides and/or other chemicals into the water for application during irrigation. The central pivot 14 may supply water to a conduit 18 or pipe which carries the water along the length of the spans 16.

The irrigation system 10 may comprise up to dozens of spans 16. The exemplary irrigation system 10 shown in the figures includes three spans 16A, 16B, 16C. Each span 16 includes a truss section 20 (20A, 20B, 20C in the figures) and a mobile tower 22 (22A, 22B, 22C in the figures). The truss section 20 includes a plurality of beams rigidly connected to one another to form a framework which carries or otherwise supports the conduit 18 and other fluid distribution mechanisms that are connected in fluid communication to the conduit 18. Fluid distribution mechanisms may include sprayers, diffusers, or diffusers, each optionally attached to a drop hose, or the like. In addition, the conduit 18 may include one or more valves which control the flow of water through the conduit 18. The opening and closing of the valves may be automatically controlled with an electronic signal or digital data.

The mobile tower 22 is positioned at the outward end of the span 16 and includes at least two wheels 24, at least one of which is driven by a drive motor 26. The drive motor 26 includes an electric motor, such as an alternating current (AC) motor or a direct current (DC) motor, and may drive the wheel 24 directly or through a drive shaft in order to propel the mobile tower 22 forward or backward. The operation of the drive motor 26 may be controlled by a variable frequency drive (VFD) motor controller. The drive motor 26, or the controller, may receive control signals and/or data about its operation, such as whether to turn on or off, the speed of travel, and the direction of travel, either wirelessly or hard wired through cables. The drive motor 26 may also receive electric power from an electric power source that resides locally on the mobile tower 22, such as a battery, or is electrically connected from a remote source.

The drive motor 26 may further include, or be coupled to, a gearbox 28 configured to transfer power from the drive motor 26 to the wheels 24 at low speeds with high torque. The gearbox 28 includes a plurality of gears coupled to one another in a particular configuration with one gear being coupled to the drive motor 26 and another gear being coupled to the wheels to provide the desired torque and/or other parameters. The gearbox may require a viscous fluid to provide proper lubrication of the moving parts.

Each mobile tower 22 further includes a plurality of beams rigidly connected to one another to form a framework which couples the conduit 18 and the truss section 20 to the wheels 24 and the drive motor 26.

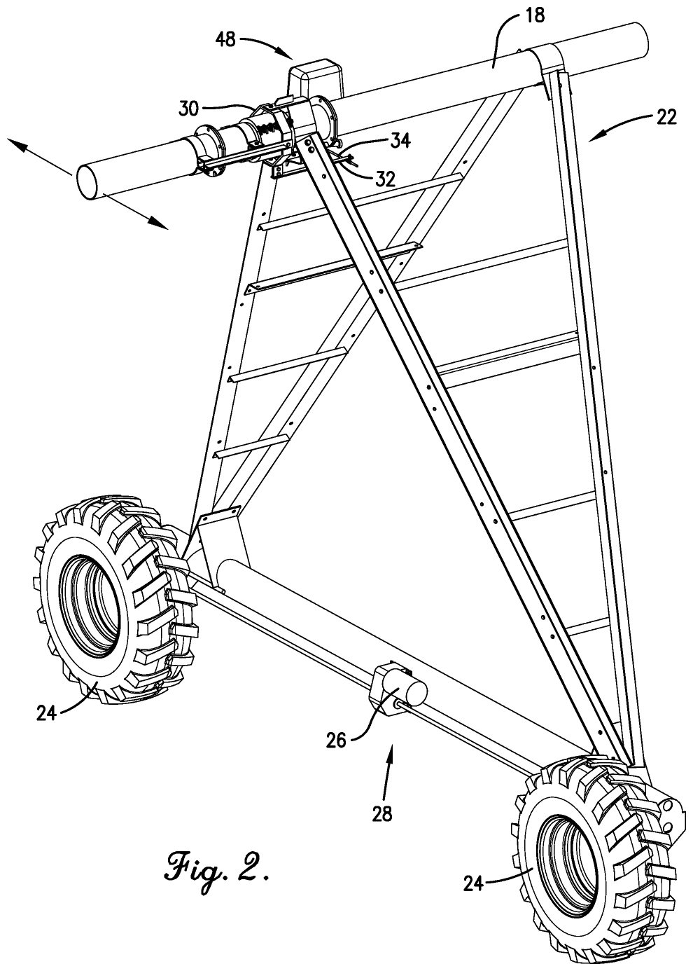

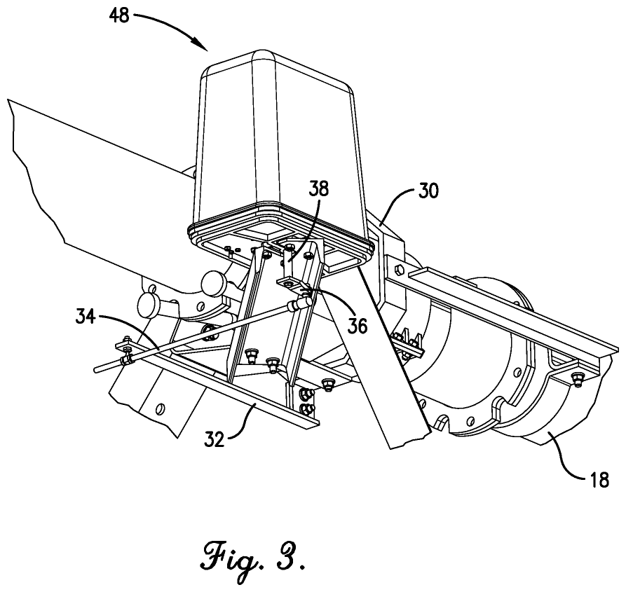

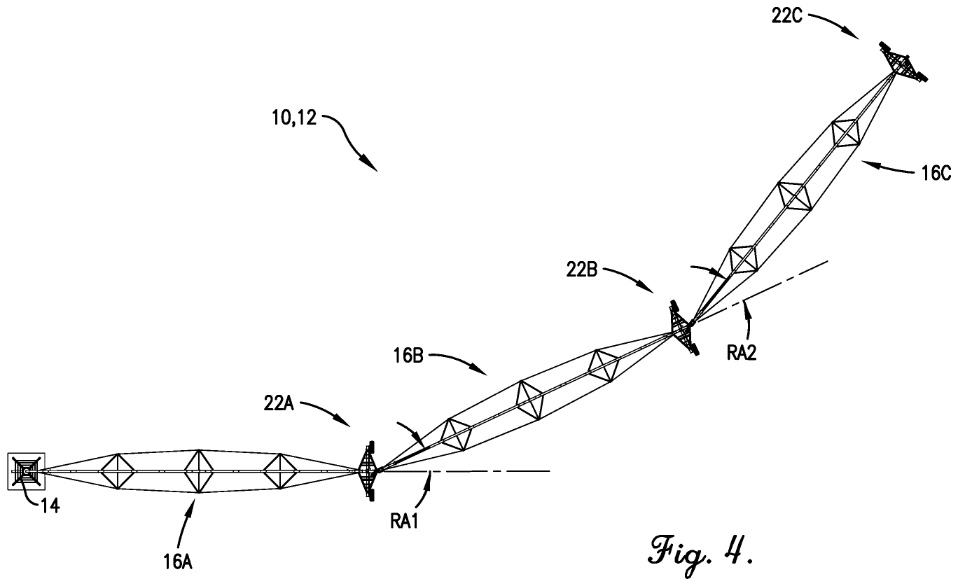

Referring to FIGS. 2 and 3, each span 16 includes joint components where a section of conduit 18 associated with one span 16 couples to a section of conduit 18 associated with an adjacent span 16, which forms a joint in the conduit 18 at the inward end of each span 16. The conduit 18 is configured to rotate, pivot, or flex at the joint when the outward span 16 moves with respect to the inward span 16, as would occur when the outward span 16 is propelled at a different speed from the inward span 16 or when the outward span 16 is operated for different periods of time at the same or similar speeds compared to the inward span 16. The joint components include an alignment ring 30, a linkage bar 32, a linkage rod 34, a linkage joint 36, and an alignment shaft 38. The alignment ring 30 encircles the conduit 18 and moves or shifts when the outward span 16 moves with respect to the inward span 16. A first end of the linkage bar 32 is rigidly coupled to the alignment ring 30. The linkage bar 32 moves in a first direction when the alignment ring 30 moves or shifts. A first end of the linkage rod 34 is rotatably coupled to a second end of the linkage bar 32. The linkage rod 34 moves in a second direction, roughly transverse to the first direction, when the linkage bar 32 moves. A first end of the linkage joint 36 is rotatably coupled to a second end of the linkage rod 34. A second end of the linkage joint 36 is rigidly coupled to the alignment shaft 38. The linkage joint 36 converts the general translational movement of the linkage rod 34 to rotation movement, such that a rotation angle of the alignment shaft 38 varies according to, is proportional to, or corresponds to, a tower to tower alignment angle, which is also a rotation angle (RA1, RA2) between a centerline of the section of conduit 18 associated with the outward span 16 or mobile tower 22 and a centerline of the section of conduit 18 associated with the inward span 16 or mobile tower 22, as shown in FIG. 4.

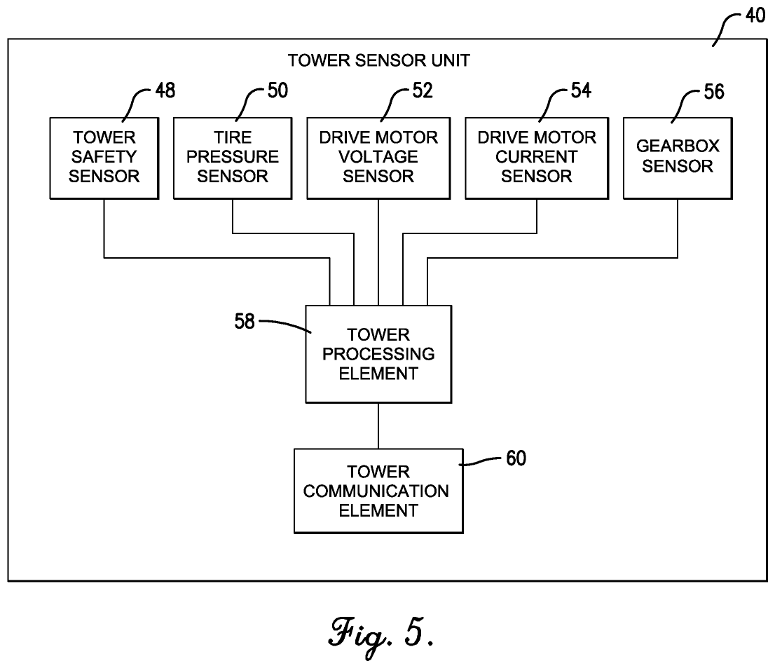

Referring to FIGS. 5-7, the fault notification system 12 monitors the irrigation system 10 for faults and issues a notification when a fault occurs. The fault notification system 12 includes a plurality of tower sensor units 40, a central communication element 42, a user interface 44, and a central processing element 46. Each tower sensor unit 40 is associated with a successive one of the mobile towers 22. The tower sensor unit 40 monitors or senses the condition or status of the operational components of the mobile tower 22 and broadly comprises a tower safety sensor 48, a tire pressure sensor 50, a drive motor voltage sensor 52, a drive motor current sensor 54, a gearbox sensor 56, an optional tower communication element 58, and a tower processing element 60.

The tower safety sensor 48 monitors or senses the rotation angle (RA1, RA2) of each mobile tower 22 with respect to its inward adjacent mobile tower 22, as shown in FIG. 4. Specifically, the tower safety sensor 48 monitors or senses the rotation angle of each section of the conduit 18 with respect to its inward section of conduit 18. The tower safety sensor 48 outputs a tower safety signal or digital data that varies according to a safety condition of the mobile tower 22 as determined by the rotation angle. For example, if the rotation angle of the mobile tower 22 is within a first range of angles, say between −15 degrees and +15 degrees, then the mobile tower 22 is likely in a safe condition, and the output of the tower safety sensor 48 is the tower safety signal with a first level or data with a first value. If the rotation angle of the mobile tower 22 is outside of the first range, then the mobile tower 22 is likely in an unsafe condition, and the output of the tower safety sensor 48 is the tower safety signal with a second level or data with a second value.

The tower safety sensor 48 may additionally or alternatively monitor or sense a relationship at each mobile tower 22 between the inward span 16 and the outward span 16. The relationship may include a rotational angle, such as RA1, RA2, or other angle or other parameter of the inward span 16 compared with the outward span 16. The tower safety sensor 48 may output the tower safety signal with a level or digital data that varies according to the relationship at the mobile tower 22 between the inward span 16 and the outward span 16. For example, the tower safety signal may have a first level or data value if the relationship between the two spans is normal, such as a rotation angle value within normal range. The tower safety signal may have a second level or data value if the relationship between the two spans is not normal, such as a rotation angle value outside the normal range.

Some embodiments of the tower safety sensor 48 include a cam rigidly connected to the alignment shaft 38 (of the conduit joint components) such that rotation of the alignment shaft 38 rotates the cam. The cam may be disc shaped and may include at least one depression that occupies an angular range along the circumference of the cam. The angular range of the depression corresponds to, or is proportional to, the first range of rotation angles that indicate that the mobile tower 22 is likely in a safe condition. Also included with this embodiment of the tower safety sensor 48 is a limit switch coupled to a roller arm. The roller is positioned to contact the depression on the cam when the mobile tower 22 has a rotation angle in the range of angles that indicate a safe condition. The limit switch is binary and the roller being in contact with the depression places the limit switch in a first state. If the mobile tower 22 rotates into an unsafe condition, then the cam rotates so that the roller is no longer within the depression. The roller being out of contact with the depression places the limit switch in a second state. When the limit switch is in the first state, the tower safety sensor 48 outputs the tower safety signal having a first level, as discussed above. When the limit switch is in the second state, the tower safety sensor 48 outputs the tower safety signal having a second level. A more detailed discussion of the cam and the limit switch is described in U.S. Pat. No. 9,538,712, issued Jan. 10, 2017 and incorporated by reference into the current document in its entirety.

Other embodiments of the tower safety sensor 48 include a potentiometer rigidly connected to the alignment shaft 38 such that rotation of the alignment shaft 38 rotates the shaft of the potentiometer. The potentiometer outputs an electric voltage, an electric current, or an electric resistance which varies according to the rotation angle of the mobile tower 22. Thus, the potentiometer outputs electric voltage, current, or resistance with a first range of values when the mobile tower 22 is in a safe condition and a second range of values when the mobile tower 22 is in an unsafe condition. It is also possible that the tower safety sensor 48 may further include an analog to digital converter (ADC) to convert the voltage, current, or resistance to digital data. Alternatively, the tower safety sensor 48 may include a rotary encoder rigidly connected to the alignment shaft 38 such that rotation of the alignment shaft 38 rotates the shaft of the rotary encoder. The rotary encoder outputs digital data or a code which varies according to the rotation angle of the mobile tower 22. Thus, the rotary encoder outputs digital data or a code with a first range of values when the mobile tower 22 is in a safe condition and a second range of values when the mobile tower 22 is in an unsafe condition.

Still other embodiments of the tower safety sensor 48 may include an analog proximity sensor, an analog laser proximity sensor, or an analog ultrasonic proximity sensor which measure the angular deflection of the sections of conduit 18 of adjacent spans 16 relative to one another. In addition, the tower safety sensor 48 may include strain or stress measurement devices, such as strain gauges, to measure the strain or stress on the sections of conduit 18 caused by the angular deflection on the conduit 18 due to the joint of two sections of conduit 18. Alternatively, the tower safety sensor 48 may include a location detection device that determines a current geolocation of the mobile tower 22 by receiving and processing radio frequency (RF) signals from a multi-constellation global navigation satellite system (GNSS) such as the global positioning system (GPS) and/or correction or enhancement information from terrestrial reference stations utilizing real-time kinematic (RTK) standards or protocols.

The tire pressure sensor 50 monitors or senses a pressure of a tire for each wheel 24 of the mobile tower 22. The tire pressure sensor 50 outputs a tire pressure signal or digital data that varies according to the pressure of the tires. In some embodiments, the tire pressure sensor 50 may output a single tire pressure signal or digital data that has a first level or data value if the pressure of all of the tires is within normal parameters and a second level or data value if the pressure of any of the tires falls below normal. In other embodiments, the tire pressure sensor 50 may output a plurality of tire pressure signals or data values, one for each of the tires of the mobile tower 22. Each tire pressure signal or digital data may have a first level or data value if the pressure of the associated tire is within normal parameters and a second level or data value if the pressure of the associated tire falls below normal. The tire pressure sensor 50 may include any type of pressure sensor that measures the tire pressure directly or indirectly.

The drive motor voltage sensor 52 monitors or senses an electric voltage level of the drive motor 26 of the mobile tower 22. The drive motor voltage sensor 52 outputs a drive motor voltage signal or digital data that varies according to the voltage level of the drive motor 26. The drive motor voltage signal or digital data has a first level or data value if the voltage is within normal parameters and a second level or data value if the voltage is either above or below normal levels. The drive motor voltage sensor 52 may include sensing electrical or electronic circuitry configured to sense electric voltage levels.

The drive motor current sensor 54 monitors or senses an electric current level of the drive motor 26 of the mobile tower 22. The drive motor current sensor 54 outputs a drive motor current signal or digital data that varies according to the current level of the drive motor 26. The drive motor current signal or digital data has a first level or data value if the current is within normal parameters and a second level or data value if the current is either above or below normal levels. The drive motor current sensor 54 may include sensing electrical or electronic circuitry configured to sense electric current levels.

The gearbox sensor 56 monitors or senses a status of the gearbox 28 coupled to the drive motor 26. The gearbox sensor 56 outputs a gearbox signal or digital data that varies according to the status of the gearbox 28. The gearbox signal or digital data has a first level or data value if all parameters of the gearbox 28 are within normal ranges and a second level or data value if the gearbox 28 any kind of fault. The gearbox sensor 56 may include a plurality of sensors such as a temperature sensor, a pressure sensor, a viscosity sensor, a torque sensor, or any other suitable sensor. The temperature sensor may sense a temperature within the gearbox 28. The pressure sensor may sense a pressure, such as a fluid pressure, within the gearbox 28. The viscosity sensor may sense a viscosity of the lubricant within the gearbox 28. The torque sensor may sense a torque output by the gearbox 28. Other sensors, or one or more the sensors already listed, may sense a contaminant level of the lubricant. Each sensor may output a signal or digital data which indicates whether the sensed property is normal or abnormal. Thus, the gearbox sensor 56 may output the gearbox signal or digital data having the first level or value when all of the sensed properties are normal and the second level or value when any one of the sensed properties is abnormal.

The tower communication element 58 generally allows the tower processing element 60 to communicate with the central processing element 46. The tower communication element 58 may include signal and/or data transmitting and receiving circuits, such as antennas, amplifiers, filters, mixers, oscillators, digital signal processors (DSPs), and the like. The tower communication element 58 may establish communication wirelessly by utilizing radio frequency (RF) signals and/or data that comply with communication standards such as cellular 2G, 3G, 4G, Voice over Internet Protocol (VoIP), LTE, Voice over LTE (VoLTE), or 5G, Institute of Electrical and Electronics Engineers (IEEE) 802.11 standard such as WiFi, IEEE 802.16 standard such as WiMAX, Bluetooth™, or combinations thereof. In addition, the control communication element 46 may utilize communication standards such as ANT, ANT+, Bluetooth™ low energy (BLE), the industrial, scientific, and medical (ISM) band at 2.4 gigahertz (GHz), or the like. The tower communication element 58 may be in electronic communication with the tower processing element 60.

The tower processing element 60 may comprise one or more processors. The tower processing element 60 may include electronic hardware components such as microprocessors (single-core or multi-core), microcontrollers, digital signal processors (DSPs), field-programmable gate arrays (FPGAs), analog and/or digital application-specific integrated circuits (ASICs), or the like, or combinations thereof. The tower processing element 60 may generally execute, process, or run instructions, code, code segments, code statements, software, firmware, programs, applications, apps, processes, services, daemons, or the like. The tower processing element 60 may also include hardware components such as registers, finite-state machines, sequential and combinational logic, configurable logic blocks, and other electronic circuits that can perform the functions necessary for the operation of the current invention. In certain embodiments, the tower processing element 60 may include multiple computational components and functional blocks that are packaged separately but function as a single unit. The tower processing element 60 may be in electronic communication with the other electronic components through serial or parallel links that include universal busses, address busses, data busses, control lines, and the like.

The tower processing element 60 may include, perhaps as an embedded device or an integrated device, or be in electronic communication with, a memory element. The memory element may be embodied by devices or components that store data in general, and digital or binary data in particular, and may include exemplary electronic hardware data storage devices or components such as read-only memory (ROM), programmable ROM, erasable programmable ROM, random-access memory (RAM) such as static RAM (SRAM) or dynamic RAM (DRAM), cache memory, hard disks, floppy disks, optical disks, flash memory, thumb drives, universal serial bus (USB) drives, or the like, or combinations thereof. In some embodiments, the memory element may be embedded in, or packaged in the same package as, the tower processing element 60. The memory element may include, or may constitute, a non-transitory “computer-readable medium”. The memory element may store the instructions, code, code statements, code segments, software, firmware, programs, applications, apps, services, daemons, or the like that are executed by the tower processing element 60. The memory element may also store data that is received by the tower processing element 60 or the device in which the tower processing element 60 is implemented. The tower processing element 60 may further store data or intermediate results generated during processing, calculations, and/or computations as well as data or final results after processing, calculations, and/or computations. In addition, the memory element may store settings, data, documents, sound files, photographs, movies, images, databases, and the like.

The tower processing element 60 may be operable, configured, or programmed to perform the following functions by utilizing hardware, software, firmware, or combinations thereof. The tower processing element 60 receives the signal or digital data from each of the sensor components, that is, the tower safety sensor 48, the tire pressure sensor 50, the drive motor voltage sensor 52, the drive motor current sensor 54, and the gearbox sensor 56. The signals or digital data may be received at regular intervals. The normal operating signal levels and/or data values for each component of the mobile tower 22 may be stored in the memory element which can be accessed by the tower processing element 60. For example, operating signal levels and/or data values stored in the memory element may indicate rotation angles for a safe condition of the mobile tower 22, normal pressure for the tires of the mobile tower 22, normal voltage and current for the drive motor 26, normal temperature, pressure, viscosity, torque, and contaminant level for the gearbox 28. The tower processing element 60 may compare the signal or digital data from each component with its normal operating level or value. If any signal or digital data is outside its normal level or value, then the tower processing element 60 generates and transmits a message to the central processing element 46 that a fault has occurred and to request that all drive motors 26 be shut down or at least its associated drive motor 26 be shut down. The message may include a first code or data that identifies the mobile tower 22 transmitting the message and a second code or data that identifies the component having the unsafe condition or fault. Alternatively, or additionally, the message may include a third code or data that identifies the type of problem or fault. In certain embodiments, the tower processing element 60 generates and transmits the message to the central processing element 46 to request that all drive motors 26 be shut down only if the signal level or data value from the tower safety sensor 48 indicates that the rotation angle of the mobile tower 22 is in an unsafe range. The message may only include the code or data that identifies the mobile tower 22 transmitting the message.

The tower processing element 60 may also generate and transmit a drive motor signal or digital data which is received by the drive motor 26 or its controller that controls the operation of the drive motor 26 including turning on or off, time period of operation, a speed of travel, and a direction of travel.

In certain embodiments, when the tower safety sensor 48 outputs the signal or digital data which indicates that, based on the rotation angle, the mobile tower 22 is in an unsafe condition, the associated drive motor 26 may automatically be shut down, such as by opening a circuit breaker, or otherwise interrupting electrical power to one or more drive motors 26. Or, the tower processing element 60 may receive the unsafe condition signal or digital data from the tower safety sensor 48 and transmit the drive motor signal instructing the drive motor 26 to shut down.

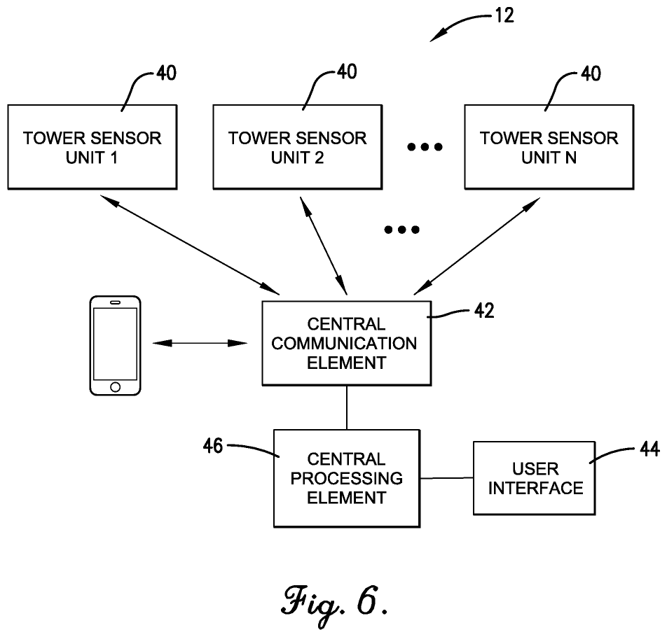

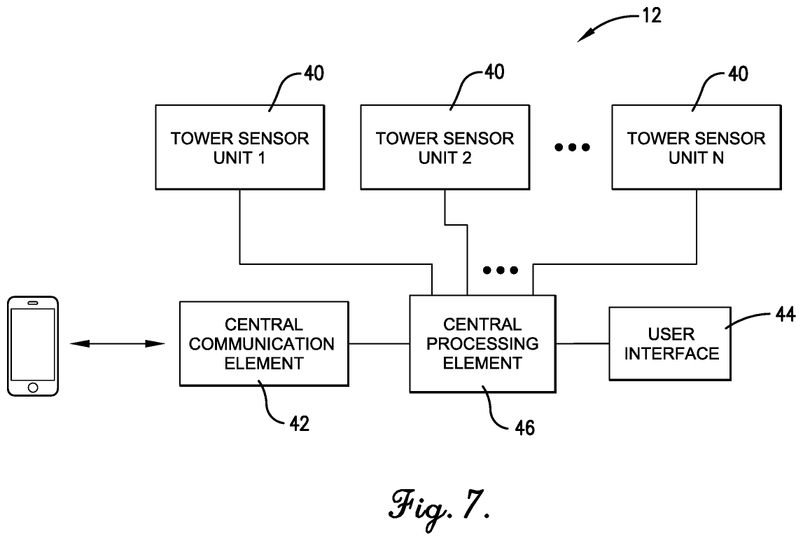

Utilizing the optional tower communication element 58, each tower sensor unit 40 may transmit the message generated by the tower processing element 60 to the central processing element 46 wirelessly as shown in FIG. 6. Alternatively, each tower sensor unit 40 may transmit the message generated by the tower processing element 60 to the central processing element 46 directly through wiring or cables as shown in FIG. 7.

The central communication element 42 generally allows the central processing element 46 to communicate wirelessly with the tower communication elements 58 (if utilized) as well as mobile electronic devices, external systems, networks, and the like. The central communication element 42 may include substantially the same structure or components as the tower communication element 58 discussed above. The central communication element 42 may be in electronic communication with the central processing element 46.

The user interface 44 generally allows the user to utilize inputs and outputs to interact with the central processing element 46. The user interface 44 may be retained in a housing located at, or near, the central pivot. Inputs may include a touchscreen, buttons, pushbuttons, knobs, jog dials, shuttle dials, directional pads, multidirectional buttons, switches, keypads, keyboards, mice, joysticks, microphones, or the like, or combinations thereof. Outputs may include a display, audio speakers, lights, dials, meters, or the like, or combinations thereof. The user interface 44 may be located onsite with the irrigation system 10—typically on, or in the vicinity of, the central pivot 14. Additionally, or alternatively, the user interface 44 may include a software interface that is implemented in a mobile electronic device application, a desktop or laptop computer application, a website application, or the like. The user interface 44 allows the user to interact with the central processing element 46 to control the features, functions, and operation of the irrigation system 10.

The central processing element 46 may include substantially the same structure or components as each of the tower processing elements 60 described above. Thus, the central processing element 46 may include, or be in electronic communication with, a memory element. The central processing element 46 may be located onsite with the irrigation system 10, such as at, or in proximity to, the central pivot 14. Alternatively, the central processing element 46 may be located remotely, away from the irrigation system 10. Furthermore, the central processing element 46 may be operable, configured, or programmed to perform the following functions by utilizing hardware, software, firmware, or combinations thereof. The central processing element 46 monitors communication from each of the tower processing elements 60 and receives a message from one or more tower processing elements 60 that requests a shut down of all drive motors 26 in the event of a problem or fault or at least the drive motor 26 associated with the tower processing element 60 requesting the shut down. The central processing element 46 in turn generates and transmits a shut down signal or digital data to each tower processing element 60 to output the drive motor signal to instruct each drive motor 26 to shut down. Each tower processing element 60 then outputs the drive motor signal with a signal level or data value that shuts the associated drive motor 26 off. Alternatively, the central processing element 46 may directly shut down each drive motor 26 by opening a main circuit breaker. In some embodiments, the central processing element 46 generates and transmits a shut down signal or digital data to the tower processing element 60 originally requesting the shut down only to output the drive motor signal to instruct its drive motor 26 to shut down. The central processing element 46 also communicates a notification on the user interface 44 which can be viewed by an operator or a technician who inspects the irrigation system 10 onsite. In addition, the central processing element 46 communicates the notification, such as email, text message, or voice mail, through the central communication element 42 to an owner, an operator, or a technician associated with the irrigation system 10 that a problem or fault has occurred. The notification may include data or a code indicating which mobile tower 22 has the problem or fault and what the problem or fault is.

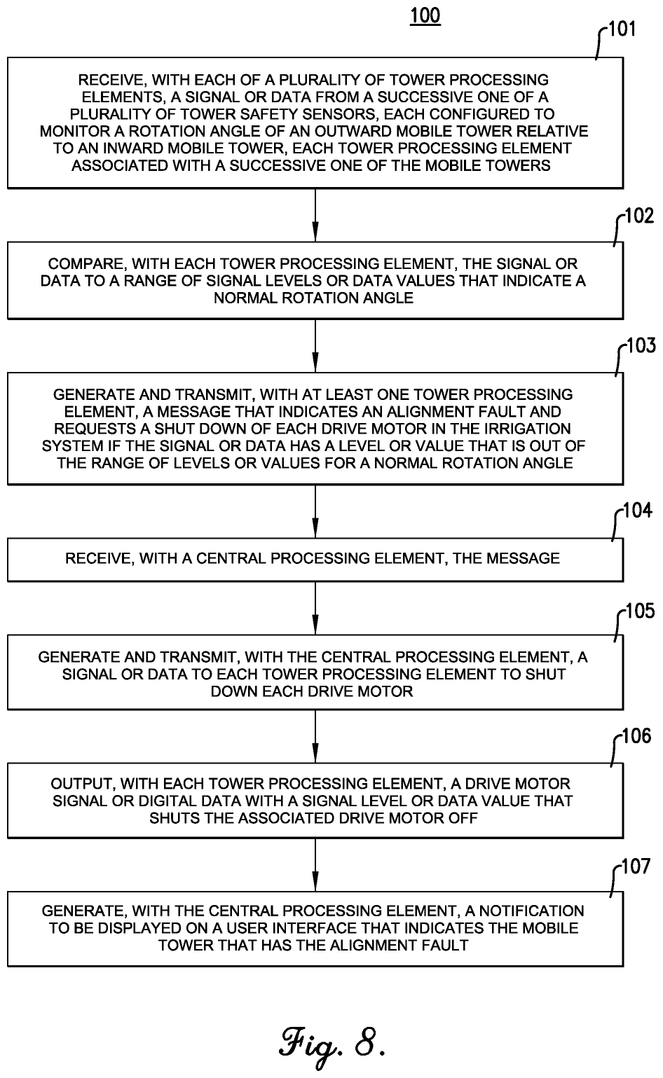

FIG. 8 depicts a listing of at least a portion of the steps of an exemplary method 100 for monitoring an irrigation system 10 including a plurality of mobile towers 22, each mobile tower 22 including a drive motor 26, for mobile tower alignment faults and issuing a notification when a fault occurs. The steps may be performed in the order shown in FIG. 8, or they may be performed in a different order. Furthermore, some steps may be performed concurrently as opposed to sequentially. In addition, some steps may be optional or may not be performed.

Referring to step 101, a tower safety signal or data is received by each of a plurality of tower processing elements 60. The tower safety signal or data is received from a successive one of a plurality of tower safety sensors 48, each configured to monitor a rotation angle of an outward mobile tower 22 relative to an inward mobile tower 22. Each tower processing element 60 is associated with a successive one of the mobile towers 22.

The tower safety sensor 48 monitors or senses the rotation angle (RA1, RA2) of each mobile tower 22 with respect to its inward adjacent mobile tower 22, as shown in FIG. 4. Specifically, the tower safety sensor 48 monitors or senses the rotation angle of each section of the conduit 18 with respect to its inward section of conduit 18. The tower safety sensor 48 outputs the tower safety signal or digital data that varies according to a safety condition of the mobile tower 22 as determined by the rotation angle. For example, if the rotation angle of the mobile tower 22 is within a first range of angles, say between −15 degrees and +15 degrees, then the mobile tower 22 is likely in a safe condition, and the output of the tower safety sensor 48 is the tower safety signal with a first level or data with a first value. If the rotation angle of the mobile tower 22 is outside of the first range, then the mobile tower 22 is likely in an unsafe condition, and the output of the tower safety sensor 48 is the tower safety signal with a second level or data with a second value.

Referring to step 102, the tower safety signal or data from each tower safety sensor 48 is compared, using the associated tower processing element 60, to a range of signal levels or data values that indicate a normal rotation angle. The range of signal levels or data values for a normal rotation angle may be stored in a memory element embedded in, or in electronic communication with, each tower processing element 60.

Referring to step 103, a message is generated and transmitted, from at least one tower processing element 60, that indicates an alignment fault and requests a shut down of at least one drive motor 26 in the irrigation system 10 if the tower safety signal or data has a level or value that is out of the range of levels or values for a normal rotation angle. The message may include a code or data that identifies the mobile tower 22 whose tower processing element 60 is transmitting the message.

Referring to step 104, the message is received by a central processing element 46. The central processing element 46 monitors communication from each of the tower processing elements 60.

Referring to step 105, a shut down signal or data is generated and transmitted from the central processing element 46 to each tower processing element 60 to shut down at least one drive motor 26.

Referring to step 106, a drive motor signal or digital data is output by at least one tower processing element 60 in response to receiving the shut down signal from the central processing element 46. The drive motor signal or digital data is received by the drive motor 26 or its controller and controls the operation of the drive motor 26 including turning on or off, a speed of travel, and a direction of travel. In this instance, the drive motor signal or digital data has a signal level or data value that shuts the associated drive motor 26 off.

Referring to step 107, a notification is generated by the central processing element 46 which is displayed on a user interface 44 that indicates the mobile tower 22 that has the alignment fault. The user interface 44 generally allows the user to utilize inputs and outputs to interact with the central processing element 46 and may be located onsite with the irrigation system 10—typically on, or in the vicinity of, the central pivot 14. The notification can be viewed by an operator or a technician who inspects the irrigation system 10 onsite. In addition, the central processing element 46 communicates the notification, such as email, text message, or voice mail, through the central communication element 42 to an owner, an operator, or a technician associated with the irrigation system 10 that a problem or fault has occurred. The notification may include data or a code indicating which mobile tower 22 has the problem or fault and what the problem or fault is.

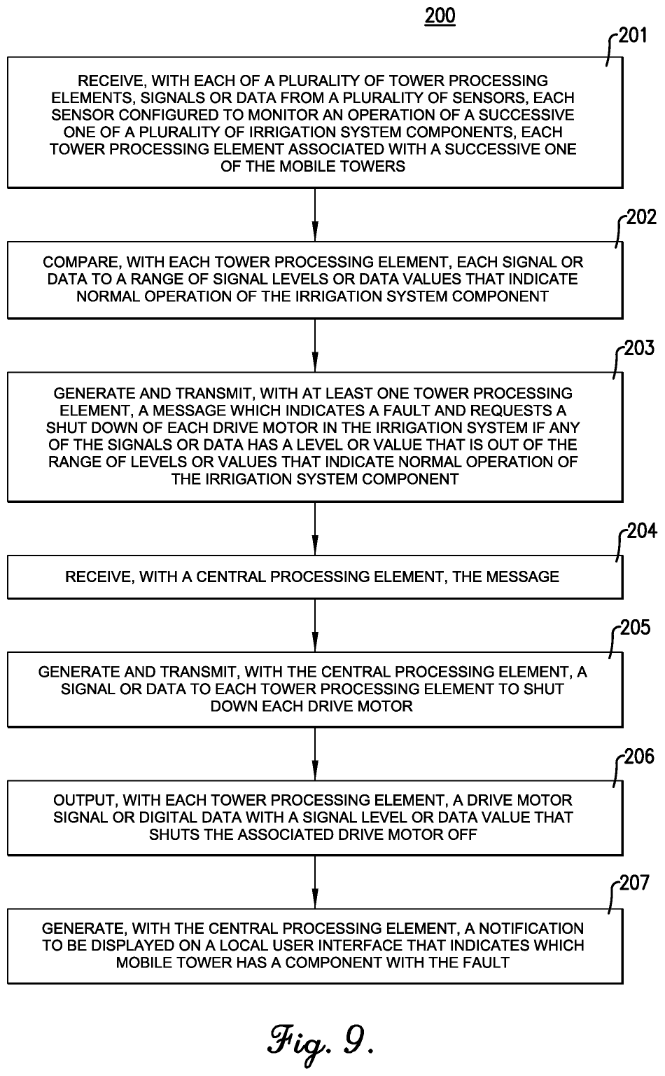

FIG. 9 depicts a listing of at least a portion of the steps of an exemplary method 200 for monitoring an irrigation system 10 including a plurality of mobile towers 22, each mobile tower 22 including a drive motor 26, for faults and issues a notification when a fault occurs. The steps may be performed in the order shown in FIG. 9, or they may be performed in a different order. Furthermore, some steps may be performed concurrently as opposed to sequentially. In addition, some steps may be optional or may not be performed.

Referring to step 201, signals or data are received by each of a plurality of tower processing elements 60, each tower processing element 60 associated with a successive one of the mobile towers 22. The signals or data are received from a plurality of sensors 48, 50, 52, 54, 56, each sensor 48, 50, 52, 54, 56 configured to monitor an operation of a successive one of a plurality of irrigation system components. The sensors include a tower safety sensor 48, a tire pressure sensor 50, a drive motor voltage sensor 52, a drive motor current sensor 54, and a gearbox sensor 56. The tower safety sensor 48 monitors or senses the rotation angle (RA1, RA2) of each mobile tower 22 with respect to its inward adjacent mobile tower 22, as shown in FIG. 4. The tower safety sensor 48 outputs a signal or digital data that varies according to a safety condition of the mobile tower 22 as determined by the rotation angle.

The tire pressure sensor 50 monitors or senses a pressure of a tire for each wheel 24 of the mobile tower 22. The tire pressure sensor 50 outputs a signal or digital data that varies according to the pressure of the tires.

The drive motor voltage sensor 52 monitors or senses an electric voltage level of the drive motor 26 of the mobile tower 22. The drive motor voltage sensor 52 outputs a signal or digital data that varies according to the voltage level of the drive motor 26.

The drive motor current sensor 54 monitors or senses an electric current level of the drive motor 26 of the mobile tower 22. The drive motor current sensor 54 outputs a signal or digital data that varies according to the current level of the drive motor 26.

The gearbox sensor 56 monitors or senses a status of the gearbox 28 coupled to the drive motor 26. The gearbox sensor 56 outputs a signal or digital data that varies according to the status of the gearbox 28.

Referring to step 202, each signal or data is compared, by each tower processing element 60, to a range of signal levels or data values that indicate normal operation of the irrigation system component. The range of signal levels or data values for each sensor 48, 50, 52, 54, 56 may be stored in a memory element embedded in, or in electronic communication with, each tower processing element 60. The tower processing element 60 receives the signal or digital data from each of the sensor components, that is, the tower safety sensor 48, the tire pressure sensor 50, the drive motor voltage sensor 52, the drive motor current sensor 54, and the gearbox sensor 56. The signals or digital data may be received at regular intervals. The normal operating signal levels and/or data values for each component of the mobile tower 22 may be stored in the memory element which can be accessed by the tower processing element 60. For example, operating signal levels and/or data values stored in the memory element may indicate rotation angles for a safe condition of the mobile tower 22, normal pressure for the tires of the mobile tower 22, normal voltage and current for the drive motor 26, normal temperature, pressure, viscosity, and torque for the gearbox 28. The tower processing element 60 may compare the signal or digital data from each component with its normal operating level or value.

Referring to step 203, a message is generated and transmitted, from at least one tower processing element 60, which indicates a fault and requests a shut down of at least one drive motor 26 in the irrigation system 10 if any of the signals or data has a level or value that is out of the range of levels or values that indicate normal operation of the irrigation system component. The message may include a first code or data that identifies the mobile tower 22 transmitting the message and a second code or data that identifies the component having the unsafe condition or fault. Alternatively, or additionally, the message may include a third code or data that identifies the type of problem or fault.

Referring to step 204, the message is received by a central processing element 46. The central processing element 46 monitors communication from each of the tower processing elements 60.

Referring to step 205, a shut down signal or data is generated and transmitted from the central processing element 46 to each tower processing element 60 to shut down at least one drive motor 26.

Referring to step 206, a drive motor signal or digital data is output by at least one tower processing element 60. The drive motor signal or digital data is received by the drive motor 26 or its controller and controls the operation of the drive motor 26 including turning on or off, a speed of travel, and a direction of travel. In this instance, the drive motor signal or digital data has a signal level or data value that shuts the associated drive motor 26 off.

Referring to step 207, a notification is generated by the central processing element 46 which is displayed on a user interface 44 that indicates the mobile tower 22 that has the fault. The user interface 44 generally allows the user to utilize inputs and outputs to interact with the central processing element 46 and may be located onsite with the irrigation system 10—typically on, or in the vicinity of, the central pivot 14. The notification can be viewed by an operator or a technician who inspects the irrigation system 10 onsite. In addition, the central processing element 46 communicates the notification, such as email, text message, or voice mail, through the central communication element 42 to an owner, an operator, or a technician associated with the irrigation system 10 that a problem or fault has occurred. The notification may include data or a code indicating which mobile tower 22 has the problem or fault and what the problem or fault is.

### Additional Considerations

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A fault notification system for monitoring an irrigation system including a plurality of mobile towers and a plurality of spans, each mobile tower including a drive motor and each span positioned between two adjacent mobile towers, for faults and issuing a notification when a fault occurs, the fault notification system comprising:
a plurality of tower sensor units, each tower sensor unit including
a tower safety sensor configured to monitor or sense a relationship at each mobile tower between an inward span and an outward span and output a tower safety signal or digital data that varies according to the relationship, and
a tower processing element configured or programmed to receive the tower safety signal or digital data from the tower safety sensor,
compare a signal level or data value of the tower safety signal or digital data with a range of signal levels or data values indicating a normal relationship, and
generate and transmit a message that a fault has occurred; and
a central processing element configured or programmed to receive the message from the tower processing element, and
communicate a notification to a user interface, the notification indicating which mobile tower has the fault.

2. The fault notification system of claim 1, wherein
the processing element of each tower sensor unit is further configured or programmed to request that each drive motor of the irrigation system be shut down if the signal level or data value of the tower safety signal or digital data is out of the range of signal levels or data values indicating a normal relationship, and
the central processing element is further configured or programmed to generate and transmit a shut down signal or digital data to each tower processing element to output a drive motor signal to instruct each drive motor to shut down.

3. The fault notification system of claim 1, wherein
the tower sensor unit further includes a tire pressure sensor configured to monitor or sense a pressure of a tire for at least one wheel of the mobile tower and output a tire pressure signal or digital data that varies according to the pressure of the tire, and
the tower processing element is further configured or programmed to receive the tire pressure signal or digital data from the tire pressure sensor,
compare a signal level or data value of the tire pressure signal or digital data with a range of signal levels or data values indicating a normal pressure, and
generate and transmit the message if the signal level or data value of the tire pressure signal or digital data is out of the range of signal levels or data values indicating a normal pressure.

4. The fault notification system of claim 1, wherein
the tower sensor unit further includes a drive motor voltage sensor configured to monitor or sense an electric voltage level of the drive motor of the mobile tower and output a drive motor voltage signal or digital data that varies according to the voltage level of the drive motor, and
the tower processing element is further configured or programmed to receive the drive motor voltage signal or digital data from the drive motor voltage sensor,
compare a signal level or data value of the drive motor voltage signal or digital data with a range of signal levels or data values indicating a normal voltage level, and
generate and transmit the message if the signal level or data value of the drive motor voltage signal or digital data is out of the range of signal levels or data values indicating a normal voltage level.

5. The fault notification system of claim 1, wherein
the tower sensor unit further includes a drive motor current sensor configured to monitor or sense an electric current level of the drive motor of the mobile tower and output a drive motor current signal or digital data that varies according to the current level of the drive motor, and
the tower processing element is further configured or programmed to receive the drive motor current signal or digital data from the drive motor current sensor,
compare a signal level or data value of the drive motor current signal or digital data with a range of signal levels or data values indicating a normal current level, and
generate and transmit the message if the signal level or data value of the drive motor current signal or digital data is out of the range of signal levels or data values indicating a normal current level.

6. The fault notification system of claim 1, wherein
the tower sensor unit further includes a gearbox sensor configured to monitor or sense a status of a gearbox of the mobile tower and output a gearbox signal or digital data that varies according to the status of the gearbox, and
the tower processing element is further configured or programmed to receive the gearbox signal or digital data from the gearbox sensor, compare a signal level or data value of the gearbox signal or digital data with a range of signal levels or data values indicating a normal status, and
generate and transmit the message if the signal level or data value of the gearbox signal or digital data is out of the range of signal levels or data values indicating a normal status.

7. The fault notification system of claim 6, wherein the gearbox sensor is configured to monitor or sense properties including temperature, fluid pressure, lubricant viscosity, or lubricant contaminant level within the gearbox or torque output by the gearbox and output the gearbox signal or digital data having a first level or value when all of the properties are within normal ranges and the second level or value when any one of the properties is outside of normal ranges.

8. A method for monitoring an irrigation system including a plurality of mobile towers, each mobile tower including a drive motor, for mobile tower alignment faults and issuing a notification when an alignment fault occurs, the method comprising:
receiving, with each of a plurality of tower processing elements, a tower safety signal or data from a successive one of a plurality of tower safety sensors, each tower safety sensor configured to monitor a rotation angle of an outward mobile tower relative to an inward mobile tower, each tower processing element associated with a successive one of the mobile towers;
comparing, with each tower processing element, the tower safety signal or data to a range of signal levels or data values that indicate a normal rotation angle;
generating and transmitting, with at least one tower processing element, a message that indicates an alignment fault and requests a shut down of each drive motor in the irrigation system if the tower safety signal or data has a level or value that is out of the range of levels or values for a normal rotation angle;
receiving, with a central processing element, the message;
generating and transmitting, with the central processing element, a shut down signal or data to each tower processing element to shut down each drive motor; and
outputting, with each tower processing element, a drive motor signal or digital data with a signal level or data value that shuts the associated drive motor off.

9. The method of claim 8, further comprising generating, with the central processing element, a notification to be displayed on a user interface that indicates the mobile tower which has the alignment fault.

10. The method of claim 8, further comprising transmitting an email or text message to a party associated with the irrigation system that an alignment fault has occurred.

11. A method for monitoring an irrigation system including a plurality of mobile towers, each mobile tower including a drive motor, for faults and issuing a notification when a fault occurs, the method comprising:
receiving, with each of a plurality of tower processing elements, signals or data from a plurality of sensors, each sensor configured to monitor an operation of a successive one of a plurality of irrigation system components, each tower processing element associated with a successive one of the mobile towers;
comparing, with each tower processing element, each signal or data to a range of signal levels or data values that indicate normal operation of the irrigation system component;
generating and transmitting, with at least one tower processing element, a message which indicates a fault and requests a shut down of each drive motor in the irrigation system if any of the signals or data has a level or value that is out of the range of levels or values that indicate normal operation of the irrigation system component;
receiving, with a central processing element, the message;
generating and transmitting, with the central processing element, a shut down signal or data to each tower processing element to shut down each drive motor; and
outputting, with each tower processing element, a drive motor signal or digital data with a signal level or data value that shuts the associated drive motor off.

12. The method of claim 11, further comprising generating, with the central processing element, a notification to be displayed on a user interface that indicates the mobile tower which has the fault.

13. The method of claim 11, further comprising transmitting an email, text message, or voice mail to a party associated with the irrigation system that a fault has occurred.

14. The method of claim 11, wherein the signals or data received from the sensors include a tire pressure signal or digital data that varies according to a pressure of a tire for at least one wheel of the mobile tower received from a tire pressure sensor configured to monitor or sense the pressure of the tire.

15. The method of claim 11, wherein the signals or data received from the sensors include a drive motor voltage signal or digital data that varies according to an electric voltage level of the drive motor of the mobile tower received from a drive motor voltage sensor configured to monitor or sense the voltage level of the drive motor.

16. The method of claim 11, wherein the signals or data received from the sensors include a drive motor current signal or digital data that varies according to an electric current level of the drive motor of the mobile tower received from a drive motor current sensor configured to monitor or sense the current level of the drive motor.

17. The method of claim 11, wherein the signals or data received from the sensors include a gearbox signal or digital data that varies according to a status of a gearbox of the mobile tower received from a gearbox sensor configured to monitor or sense the status of the gearbox.

18. The method of claim 17, wherein the status of the gearbox includes a temperature of the gearbox, a fluid pressure of the gearbox, a lubricant viscosity of the gearbox, or a lubricant contaminant level of the gearbox, and the gearbox signal varies according to any of the listed parameters of the gearbox.

19. The method of claim 17, wherein the status of the gearbox includes a torque output by the gearbox and the gearbox signal varies according to the torque output by the gearbox.
